(19) United States
(12) Patent Application Publication
(10) Pub. No.: US 2026/0100176 A1
(43) Pub. Date: Apr. 9, 2026

(54) METHOD, APPARATUS, AND ELECTRONIC DEVICE FOR AUDIO CREATION

(71) Applicants: Lemon Inc., Grand Cayman (KY); Douyin Vision Co., Ltd., Shijingshan District, Beijing (CN)

(72) Inventors: Daiyu Zhang, Los Angeles, CA (US); Ju-Chiang Wang, Los Angeles, CA (US); Katerina Kosta, London (GB); Jordan Smith, London (GB); Shicen Zhou, Beijing (CN)

(21) Appl. No.: 19/112,449

(22) PCT Filed: Nov. 10, 2023
(86) PCT No.: PCT/CN2023/131123

§ 371 Date: Mar. 17, 2025

(30) Foreign Application Priority Data
Nov. 28, 2022 (CN) 202211505817.5

(51) Int. Cl. G10H 1/00

(52) U.S. Cl. CPC G10H 1/0025; G10H 2210/101

(57) ABSTRACT

The disclosure provides a method, apparatus, and electronic device for audio creation. In the method, first text comprising a plurality of characters is acquired. Rhyme associated with the first text is determined based on the first text. The rhyme indicates rhythm of the plurality of characters. A first melody of the first text is determined based on the first text and the rhyme. An audio associated with the first text is generated based on the first melody and the first text. Thus, the efficiency of audio creation is improved.

This application claims priority to Chinese Patent Application No. 202211505817.5, filed with the Chinese Patent Office on Nov. 28, 2022 and entitled ‘METHOD, APPARATUS, AND ELECTRONIC DEVICE FOR AUDIO CREATION’, which is incorporated herein by reference in its entirety.

### FIELD

Embodiments of the present disclosure relate to the field of audio processing technologies, and in particular, to a method, an apparatus, and an electronic device for audio creation.

### BACKGROUND

When a music creator creates music, the music creator generally needs to create a segment of lyrics, and write a melody for the lyrics, so as to obtain a song.

Currently, a music creator may first create lyrics of a song, and then write a corresponding melody for the song, or the music creator may also first create a melody of a song, and then write a corresponding lyric for the melody. However, the above method has a high requirement for the music creator and the complexity of audio creation is higher, thereby resulting in a low efficiency of audio creation.

### SUMMARY

The present disclosure provides a method, apparatus, and electronic device for audio creation, which are used for solving the technical problem in the prior art that the efficiency of audio creation is relatively low.

According to a first aspect, the present disclosure provides a method of creating an audio. The method includes:
acquiring a first text comprising a plurality of characters;
determining rhyme associated with the first text based on the first text, the rhyme indicating rhythm of the plurality of characters;
determining a first melody of the first text based on the first text and the rhyme; and
generating an audio associated with the first text based on the first melody and the first text.

According to a second aspect, the present disclosure provides an apparatus for audio creation. The apparatus for audio creation includes a first acquiring module, a first determining module, a second determining module and a generating module, wherein:
the first acquiring module is configured to acquire a first text comprising a plurality of characters;
the first determining module is configured to determine rhyme associated with the first text based on the first text, the rhyme indicating rhythm of the plurality of characters;
the second determining module is configured to determine a first melody of the first text based on the first text and the rhyme;
the generating module is configured to generate an audio associated with the first text based on the first melody and the first text.

According to a third aspect, an embodiment of the present disclosure provides an electronic device, including: a processor and a memory;
the memory stores computer executable instructions; and
the processor performing the computer executable instructions stored in the memory, causing the processor to perform the method of creating an audio according to the first aspect.

According to a fourth aspect, an embodiment of the present disclosure provides a computer readable storage medium. The computer readable storage medium has computer executable instructions stored therein, the computer executable instructions, when performed by a processor, implementing the method of creating an audio according to the first aspect.

According to a fifth aspect, an embodiment of the present disclosure provides a computer program product including a computer program. The computer program, when being executed by a processor, implements the method of creating an audio according to the first aspect and various possible implementations of the first aspect.

The present disclosure provides a method, apparatus, and electronic device for audio creation. The electronic device may acquire a first text including a plurality of characters, and based on the first text, rhyme associated with the first text is determined, the rhyme is used to indicate the rhyme of the plurality of characters, a first melody is determined for the first text based on the first text and the rhyme, and an audio associated with the first text is generated based on the first melody and the first text. In the described method, since the electronic device may automatically write a corresponding first melody for the first text based on the first text, the electronic device may quickly create a song based on a segment of lyrics, thereby improving the efficiency of audio creation.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description are some embodiments of the present disclosure. For those skilled in the art, other drawing may also be obtained according to these drawings without creative efforts.

FIG. 1 is a schematic diagram of an application scenario according to an embodiment of the present disclosure;

FIG. 2 is a flowchart of a method of creating an audio according to an embodiment of the present disclosure;

FIG. 3 is a schematic diagram of a process for acquiring a rhyme according to an embodiment of the present disclosure;

FIG. 4 is a schematic diagram of a process for acquiring a first melody according to an embodiment of the present disclosure;

FIG. 5 is a flowchart of a method for verifying an audio according to an embodiment of the present disclosure;

FIG. 6 is a schematic diagram of a process of a method of creating an audio according to an embodiment of the present disclosure;

FIG. 7 is a schematic structural diagram of an apparatus for audio creation according to an embodiment of the present disclosure;

FIG. 8 is a schematic structural diagram of a further apparatus for audio creation according to an embodiment of the present disclosure;

FIG. 9 is a structural schematic diagram of an electronic device according to an embodiment of the present disclosure.

### DETAILED DESCRIPTION

Exemplary embodiments will be described herein in detail, examples of which are illustrated in the accompanying drawings. When the following description relates to the accompanying drawings, the same numerals in the different drawings indicate the same or similar elements unless otherwise indicated. The implementations described in the following exemplary embodiments do not represent all implementations consistent with the present disclosure. Rather, they are merely examples of apparatus and methods consistent with some aspects of the present disclosure, as detailed in the appended claims.

In order to facilitate understanding, the concept according to an embodiment of the present disclosure will be described below.

An electronic device is a device having a wireless transceiving function. The electronic device may be deployed on land, which includes an indoor or outdoor, handheld, wearable, or vehicle-mounted electronic device; or may also be deployed on a water surface (such as a ship). The electronic device may be a mobile phone, a tablet computer, a computer with a wireless transceiving function, or a virtual reality (VR) electronic devices, an augmented reality (AR) electronic device, a wireless terminal in industrial control, a vehicle-mounted electronic device, a wireless terminal in self driving, a wireless electronic device in remote medical, a wireless electronic device in smart grid, a wireless electronic devices in transportation safety, a wireless electronic device in smart city, a wireless electronic device in smart home, a wearable electronic device, and the like. The electronic device involved in the embodiments of the present disclosure may also be referred to as a terminal, a user equipment (UE), an access electronic device, a vehicle-mounted terminal, an industrial control terminal, a UE unit, a UE station, a mobile station, a remote station, a remote electronic device, a mobile device, a UE electronic device, a wireless communication device, a UE agent, a UE device, or the like. The electronic device may also be stationary or mobile.

In the related art, when a music creator creates a song, the music creator may first create lyrics, and then write an adaptive melody based on the lyrics so as to obtain a song; or the music creator may first create a melody and write adaptive lyrics based on the melody. However, any one of the described song creation methods has a high requirement for a musical creator, and the melody and lyrics usually need to be completed by a plurality of musical creators together, so that the audio creation is very complex, resulting in a low audio creation efficiency.

In order to solve the technical problem of low efficiency of music creation in the related art, an embodiment of the present disclosure provides a method of creating an audio, an electronic device acquires a first text including a plurality of characters; determines sentence structure information of the first text, determines rhyme associated with the first text based on the sentence structure information; determine a chord associated with each character in the first text based on the first text; and determine a first melody of the first text based on a plurality of chords and rhyme, then the electronic device generate an audio associated with the first text based on the first melody and the first text. In the described method, after acquiring first text, since the electronic device may automatically create a suitable melody for the first text, and then obtain audio, the electronic device may quickly create a song based on a segment of lyrics, thereby improving the efficiency of music creation.

The following describes an application scenario of an embodiment of the present disclosure with reference to FIG. 1.

FIG. 1 is a schematic diagram of an application scenario according to an embodiment of the present disclosure. Referring to FIG. 1, an electronic device is included in the application scenario. After the electronic device acquires a first lyrics, the electronic device may generate a first melody matching the first lyrics, and then generate a first song based on the first lyrics and the first melody. In this way, after a music creator inputs a segment of lyrics to an electronic device, the electronic device may automatically generate a matching melody for the segment of lyrics, and then generate a song; therefore, requirements of song creation on music creators are relatively low, and the efficiency of song creation is further improved.

It should be noted that FIG. 1 only illustrates one application scenario of the embodiments of the present disclosure by way of example and is not intended to limit the application scenarios of the embodiments of the present disclosure.

The technical solution of the present disclosure and how to solve the above technical problem using the technical solution of the present disclosure will be described in detail below with reference to specific embodiments. The following several specific embodiments may be combined with each other, and the same or similar concepts or procedures may not be repeated in certain embodiments. Embodiments of the present disclosure will be described below with reference to the accompanying drawings.

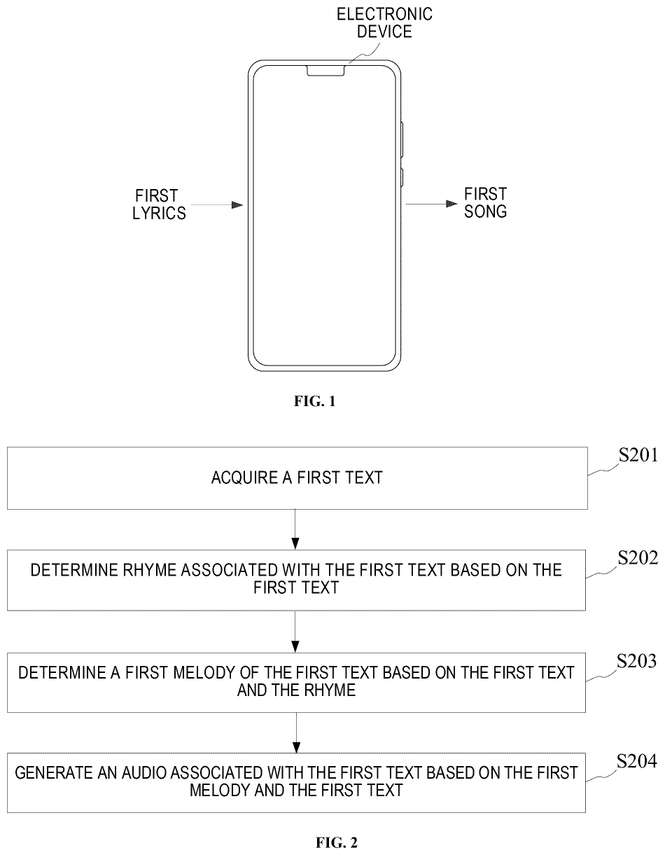

FIG. 2 is a schematic flowchart of a method of creating an audio according to an embodiment of the present disclosure. Referring to FIG. 2, the method may include the following.

At S201, a first text is acquired.

The performing subject of the embodiment of the present disclosure may be an electronic device, and it may also be an apparatus for audio creation provided in the electronic device. The apparatus for audio creation may be implemented based on software, and the apparatus for audio creation may also be implemented based on a combination of software and hardware, which is not limited in the embodiments of the present disclosure.

Optionally, the first text includes a plurality of characters. Optionally, the first text may be lyrics created by a user. For example, the first text may include a plurality of text characters. For example, if the first text is ‘current day’, the first text may include the characters ‘current’ and the characters ‘day’. It should be noted that, in the embodiments of the present disclosure, the first text may be all lyrics of one song, and the first text may also be some lyrics of one song, and the embodiments of the present disclosure are not limited thereto.

Optionally, the electronic device may receive the first text input by the user. For example, after the user creates a segment of lyrics, the segment of lyrics may be input into the electronic device, and the electronic device determines the segment of lyrics as the first text.

Optionally, the electronic device may determine lyrics of a further song as the first text. For example, the electronic device may acquire any song and determine the lyrics of the song as the first text. In this way, the electronic device may recompose a song to generate a new song, thereby improving the efficiency of song creation.

It should be noted that, the electronic device may also obtain the first text in a further manner (for example, the electronic device may obtain the first text from a further electronic device, or may also obtain the first text from a database), which is not limited in the embodiments of the present disclosure.

At S202, rhyme associated with the first text is determined based on the first text.

Optionally, the rhyme may indicate rhythm of the plurality of characters. For example, the rhyme may indicate a tonal format and a rule of rhyme of the plurality of characters in the first text. Alternatively, the electronic device may determine the rhyme based on the following feasible implementation: determining sentence structure information of the first text based on the first text and determining rhyme associated with the first text based on the sentence structure information.

Optionally, the sentence structure information is configured to indicate a sentence structure associated with the plurality of characters in the first text. For example, the sentence structure information may include structure information of each character in the first text in a sentence. For example, structural information of a character of the first text in a sentence may include an attribute of the character (such as a noun or a verb), a position of the character in the sentence (such as a subject, a predicate, etc.).

Optionally, the electronic device may determine the sentence structure information of the first text based on a predetermined algorithm. For example, the electronic device may process the first text based on a sentence structure algorithm to obtain the sentence structure information of the first text. For example, the electronic device may analyze each character in the first text by using a sentence structure analysis algorithm, so as to obtain the sentence structure information of the first text.

Optionally, determining the rhyme associated with the first text based on sentence structure information specifically includes: determining, based on the sentence structure information, a bar location, a beat location, and a playing duration associated with each character in the first text; and determining a rhyme of the first text based on the bar location, the beat location, and the playing duration associated with each character.

Optionally, a bar location associated with a character may be a bar serial number of the character in the first text. For example, the first text may include 10 bars; if a bar location associated with a character is 1, the character is located at the first bar of the 10 bars; and if a bar location associated with a character is 4, the character is at the fourth bar of the 10 bars.

Optionally, a beat location associated with a character may be a beat location of the character in a bar. For example, each bar of the first text may include 4 beats; if a character is located at the first bar of the first text and the beat location corresponding to the character is 3, the character is the third beat of the first bar; and if a character is located at the fifth bar of the first text and the beat location corresponding to the character is 3.5, the character is at the 3.5th beat of the fifth bar.

Optionally, a playing duration is configured to indicate a duration of a character in the first text. For example, when a song is created, each character has a corresponding duration in the song. For example, if the playing duration of a character in the first text is 1 second, the playing duration of the character in the song corresponding to the first text is 1 second; and if the playing duration of a character in the first text is 2 seconds, the playing duration of the character in the song corresponding to the first text is 2 seconds.

It should be noted that, after determining the first text, the electronic device may determine the number of bars and beats corresponding to the first text. For example, the first text may include 10 bars, and each bar includes 4 beats.

Optionally, determining, based on the sentence structure information, the bar location, the beat location, and the playing duration associated with each character in the first text may specifically include: for an mth character in the first text; when m is 1, determining a bar location, a beat location, and a playing duration associated with a first character based on structure information of the first character in the sentence structure information. Optionally, m is 1, 2, . . . , L, and L is the number of characters in the first text. For example, if a character is the first character in the first text, the electronic device may acquire structure information (for example, a subject, a noun, and the like) of the character, and determine, based on the structure information of the character, the bar location, the beat location, and the playing duration that are associated with the character.

Alternatively, if m is greater than 1, the electronic device may determine a bar location, a beat location, and a playing duration associated with the mth character based on a bar location, a beat location, and a playing duration associated with a (m−1)th character and the structure information of the mth character in the sentence structure information. For example, if a character is the second character in the first text, when determining the bar location, the beat location, and the playing duration of the character, the electronic device may fuse the information about the bar location, the beat location, and the playing duration of the first character, so as to determine a bar location, a beat location, and a playing duration of the second character more accurately.

It should be noted that, when the electronic device determines the bar location, the beat location, and the playing duration of the character in the first text, starting from a second character in the first text, the electronic device may determine the bar location, the beat location, and the playing duration of the current character by combining the bar location, the beat location, and the playing duration of the previous character, thereby improving accuracy of rhyme.

Optionally, after determining the bar location, the beat location, and the playing duration of each character in the first text, the electronic device may determine the rhyme corresponding to the first text. For example, if the first four characters in the first text are characters in the first bar, the playing duration of each character is 1 second, and the first character is the first beat of the bar, the second character is the second beat of the bar, the third character is the third beat of the bar, and the fourth character is the fourth beat of the bar, the rhyme of the first four characters in the first text may be obtained. The rhyme of the first text may be obtained based on the described method.

Optionally, the electronic device may process the sentence structure information of the first text based on the first model to obtain the rhyme associated with the first text. The first model may be obtained by learning a plurality of groups of first samples, where each of the groups of first samples may include sample sentence structure information and sample rhyme. For example, the electronic device may acquire sample sentence structure information 1 corresponding to the sample text 1 and sample rhyme 1 corresponding to the sample sentence structure information 1, so as to obtain a group of first samples, the group of first samples including the sample sentence structure information 1 and the sample rhyme 1. The plurality of groups of first samples may be obtained by using the method.

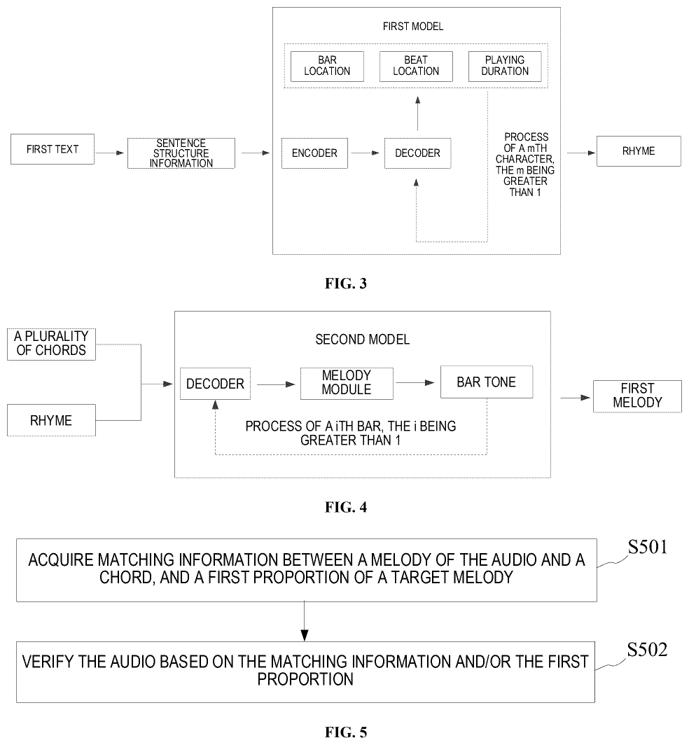

A process for processing sentence structure information by using the first model is described below with reference to FIG. 3.

FIG. 3 is a schematic diagram of a process of acquiring a rhyme according to an embodiment of the present disclosure. Referring to FIG. 3, the process includes first text and a first model. The first model includes an encoder and a decoder. The electronic device (not shown in FIG. 3) may determine sentence structure information corresponding to the first text based on the first text and inputs the sentence structure information to the encoder; and after the encoder processes the sentence structure information, a sentence structure feature is obtained, and the sentence structure feature is input to the decoder.

Please refer to FIG. 3, after the decoder receives a sentence structure feature, the decoder may perform feature reduction on the sentence structure feature Then, the bar locations, the beat locations, and the playing durations corresponding to the characters of the first text are obtained. It should be noted that, the first model may process characters in the first text according to an order in which the characters are arranged, and when the mth (m is greater than 1) character is processed, the first model may input the bar location, the beat location, and the playing duration of the (m−1)th character into the decoder. In this way, the bar location, the beat location, and the playing duration corresponding to the m character are obtained. After processing of all the characters are completed by the first model, the rhyme associated with the first text may be obtained.

It should be noted that, the electronic device may process the sentence structure information associated with the first text based on the first model, so as to obtain the rhyme associated with the first text; therefore, the electronic device may acquire a part of neural network in the first model, and determine, based on the part of neural network, the bar location, the beat location, and the playing duration associated with each character in the first text. For example, the input of the part of neural network of the first model may be sentence structure information corresponding to characters, and the output may include the bar location, the beat location, and the playing duration associated with each character; therefore, the electronic device may acquire the bar location, the beat location, and the playing duration associated with each character based on the part of neural network in the first model.

Optionally, when training the first model, the part of the neural network in the first model may also output an inter onset interval between each two characters, and then train the first model through the inter onset intervals. For example, in an actual application process, inter onset intervals between characters are also different, the inter onset interval between characters in the same bar is relatively small, and the inter onset interval between characters between bars is relatively large, and therefore, the first model may be restrained by means of the inter onset intervals, thereby improving the training accuracy of the first model and the training efficiency of the first model.

At step 203, a first melody of the first text is determined based on the first text and the rhyme.

Optionally, the first melody may indicate a tone for each character in the first text. For example, the first melody may indicate that the first character in the first text is a high pitch, the second character is a high pitch, the third character is a low pitch, etc.

Optionally, the electronic device may determine the first melody of the first text based on the following possible implementation: determining, based on the first text, a chord associated with each character in the first text; and determining the first melody of the first text based on a plurality of chords and the rhyme.

Optionally, the electronic device may match a corresponding chord for each character in the first text based on the first text. For example, when performing chord matching, the electronic device may generate an associated chord for each character according to the number of characters in the first text, and a group of chords including a plurality of chords for a plurality of characters conforms to the music theory.

Optionally, the electronic device may receive a plurality of chords associated with the first text. For example, a music creator may create a plurality of chord groups consisting of chords based on the music theory, and input the plurality of chord groups consisting of chords to the electronic device. The electronic device may determine the plurality of chord groups consisting of chords as a plurality of chords corresponding to the first text, and match a corresponding chord for each character in the first text. The electronic device may also determine a plurality of chords associated with the first text in a further manner, and embodiments of the present disclosure are not limited thereto.

Optionally, the electronic device determines the first melody of the first text based on the plurality of chords and rhyme, specifically comprises: determining a tone associated with each bar in the rhyme based on the plurality of chords. For example, the electronic device acquires a plurality of characters included in each bar and a plurality of chords associated with the plurality of characters, and then may determine a tone associated with the bar based on the plurality of chords.

Optionally, the electronic device may determine the tone associated with each bar in the rhyme based on a possible implementation as follows for an ith bar in the rhyme; when i is 1, determining a tone associated with a first bar based on a rhyme associated with the first bar and a chord associated with the first bar. Optionally, i is 1, 2, . . . , N, and N is the number of bars indicated by the rhyme. For example, if a bar is the first bar in the first text, the electronic device may acquire a plurality of chords associated with the first bar, and determine a tone associated with the first bar based on the plurality of chords and the rhyme of the ith bar.

If i is greater than 1, the tone associated with the ith bar is determined based on a tone associated with a i−1th bar, a rhyme associated with the ith bar, and a chord associated with the ith bar. For example, if a bar is the second bar indicated by the rhyme, when determining the tone of the bar, the electronic device may fuse the tone information of the first bar, and then may more accurately determine the tone associated with the second bar.

It should be noted that, when the electronic device determines the tones of the plurality of bars of the first text, starting from the second bar, the electronic device may determine the tones of the current bar by combining the tone of the previous bar, thereby improving the accuracy of determining the tones of the bars.

Optionally, after the electronic device determines the tone of each bar, the electronic device may determine the first melody based on the tone associated with each bar. For example, the first text may include 4 bars, after the electronic device determines 4 groups of tones with which the 4 bars are associated. The electronic device may splice the four groups of tones in an order of the 4 bars, and then may obtain a first melody associated with the first text. It should be noted that, when the tones are spliced, the electronic device may perform smoothing processing among each group of tones. In this way, the sudden tone change between the bars is low, and the effect of improving the tones is achieved.

Optionally, the electronic device may process a plurality of chords and rhyme associated with the first text based on the second model, so as to obtain the first melody associated with the first text. The second model may be obtained by learning a plurality of groups of second samples, and each group of second samples may include sample chords, sample rhyme and a sample melody. For example, the electronic device may acquire a plurality of sample chords 1 and sample rhyme 1 associated with sample text and acquire a sample melody associated with the plurality of sample chords 1 and the sample rhyme 1, thereby obtaining a group of second samples, the group of second samples including the plurality of sample chords 1, the sample rhyme 1 and the sample melody 1. The plurality of groups of second samples may be obtained by using the method.

The process of obtaining the first melody based on the second model will be described below with reference to FIG. 4.

FIG. 4 is a schematic diagram of a process of acquiring a first melody according to an embodiment of the present disclosure. Referring to FIG. 4, a plurality of chords, rhyme and a second model are included. The plurality of chords are chords associated with the first text and the rhyme is a rhyme associated with the first text. The electronic device (not shown in FIG. 4) may input the plurality of chords and the rhyme into the second model, and after the decoder processes the plurality of chords and the rhyme, the decoded features may be input into a melody module bar by bar.

Please refer to FIG. 4, the melody module may obtain a bar tone of each bar, and when the ith (i is greater than 1) bar is processed, the second model may input the bar tone of the (i−1)th bar into the melody module, thereby obtaining the bar tone corresponding to the ith bar. After the second model processes all of the bars, the second model may obtain the first melody associated with the first text.

It should be noted that, because the electronic device may process the rhyme and the plurality of chords associated with the first text based on the second model to obtain the first melody associated with the first text, the electronic device may determine a tone associated with each bar in the first text based on a part of neural network in the second model. For example, if the input of a group of the neural networks from layer 1 to layer 3 in the second model include rhyme associated with the first text and a plurality of chords associated with the first text, and the output may include tones associated with the plurality of bars of the first text, the electronic device may acquire the tone associated with each bar in the first text via the group of neural networks from layer 1 to layer 3.

It should be noted that, in the embodiments of the present disclosure, when training of the first model and the second model ends, the electronic device may combine the first model and the second model to obtain a combined model, and then process the first text by using the combined model to obtain audio associated with the first text.

At S204, an audio associated with the first text is generated based on the first melody and the first text.

Optionally, after the electronic device determines the first melody associated with the first text, the electronic device may process the first melody and the first text to obtain the audio, and the audio may be a song, the melody of the audio may be the first melody, and the lyrics of the audio may be the first text.

According to the method of creating an audio provided by the embodiments of the present disclosure, the electronic device acquires a first text comprising a plurality of characters, and determines sentence structure information of the first text, and determines the rhyme associated with the first text based on the sentence structure information, determines a chord associated with each character in the first text based on the first text, and determines a first melody of the first text based on the plurality of chords and the rhyme; and the electronic device may generate an audio associated with the first text based on the first melody and the first text. In the described method, after acquiring the first text, since the electronic device may automatically create a suitable melody for the first text, and then obtain the audio, the electronic device may quickly create a song based on a segment of lyrics, thereby improving the efficiency of music creation.

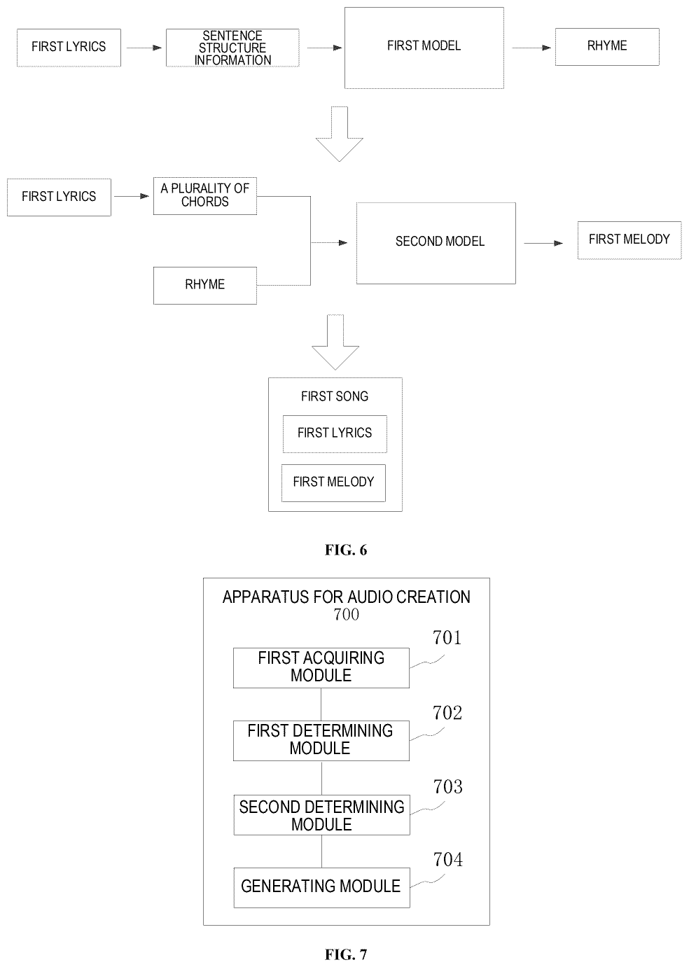

On the basis of the embodiment shown in FIG. 2, the foregoing method of creating an audio further includes a process of audio verification. The following describes a method for audio verification with reference to FIG. 5.

FIG. 5 is a schematic flowchart of a method for audio verification according to an embodiment of the present disclosure. Referring to FIG. 5, the method includes the following steps:

At S501, matching information between a melody of the audio and a chord, and a first proportion of a target melody is acquired.

Optionally, after the electronic device determines the audio, the electronic device may obtain matching information between a melody and chords of the audio. Optionally, the matching information is configured to indicate a matching degree between pitches and chords in the audio. For example, for any character in the audio, the electronic device may acquire the pitches and the chords corresponding to the characters, and then determine the matching information according to the pitches and the chords. For example, if a pitch and a chord conform the music theory, it is determined that the pitch and the chord match with each other, and if the pitch and the chord do not match, it is determined that the pitch and the chord do not match.

Optionally, the electronic device may determine, based on the audio, a first proportion of the target melody. Optionally, the target melody may have associated text in the audio. For example, with respect to any segment of audio in the audio, the electronic device may acquire a melody in the segment of audio and determine whether the melody includes corresponding text. For example, if a melody obtained by the electronic device does not include text, the melody is a non-target melody, and if the melody obtained by the electronic device includes text, the melody is a target melody.

It should be noted that, the electronic device may equally divide the first melody in the audio into a plurality of segments, so as to determine whether each segment is a target melody. For example, the electronic device may determine that each segment of melody is a melody in one second of audio, thereby determining whether each melody is a target melody. Optionally, the electronic device may also acquire the target melody based on a further manner, and embodiments of the present disclosure are not limited thereto.

Optionally, the first proportion is a proportion of the target melody in the first melody. For example, the first melody for audio is 100 seconds, if the target melody is 40 seconds, then the first proportion of the target melody is 40%, and if the target melody is 90 seconds, then the first proportion of the target melody is 90%.

At S502, the audio is verified based on the matching information and/or the first proportion.

Optionally, verifying, by the electronic device, the audio may include determining, by the electronic device, quality of the audio, and if a result of verification of the audio by the electronic device is that the verification is passed, it indicates that the quality of a song of the audio is high, and if a result of verification of the audio by the electronic device is that the verification is not passed, it indicates that the quality of the song of the audio is low.

Optionally, the electronic device may verify the audio on the basis of the matching information. Specifically, if the matching information indicates that the proportion of the number of matched pitches and chords in the audio is greater than or equal to a first threshold, the electronic device verifies the audio as passing verification, and if the matching information indicates that the proportion of the number of matched pitches and chords in the audio is less than the first threshold, the electronic device verifies the audio as failing the verification. For example, the audio includes 100 groups of pitches and chords, and if 95 groups of pitches and chords match and 5 groups of pitches and chords do not match, it indicates that the song quality of the audio is relatively high, and the verification result by the electronic device for the audio is that the verification is passed; and if 50 groups of pitches and chords match and 50 groups of pitches and chords do not match, it indicates that the song quality of the audio is relatively low, and the verification result by the electronic device for the audio is that the verification is not passed.

Optionally, the electronic device may verify the audio based on the first proportion. Specifically, if the first proportion is greater than or equal to a second threshold value, a verification result by the electronic device for the audio is that the verification is passed; and if the first proportion is less than the second threshold value, the verification result by the electronic device for the audio is that the verification is not passed. For example, if the audio includes a first melody of 100 seconds, if the target melody is 95 seconds, it indicates that the target melody occupies a relatively high proportion in the first melody, and the quality of the audio is relatively high, and the verification result by the electronic device for the audio is that the verification is passed; if the target melody is 50 seconds, it indicates that the target melody occupies a relatively low proportion in the first melody, and the quality of the audio is relatively low, and the verification result by the electronic device for the audio is that the verification is not passed.

Optionally, the electronic device may verify the audio based on the matching information and the first proportion. Specifically, if the matching information indicates that the proportion of the number of the matched pitches and chords in the audio is greater than or equal to a first threshold, and the first proportion is greater than or equal to the second threshold, the verification result by the electronic device for the audio is that the verification is passed; if the matching information indicates that the proportion of the number of the matched pitches and chords in the audio is less than a first threshold value, and the first proportion is smaller than the second threshold, the verification result by the electronic device for the audio is that the verification is not passed. For example, the audio includes 100 groups of matched pitches and chords, and the first melody duration of the audio is 100 seconds; if 95 groups of matched pitches and chords, and the first proportion is 95%, it indicates that the quality of the audio is high, and the electronic device determines that the audio passes verification; if 50 groups of matched pitches and chords, or the first proportion is 40%, it indicates that the quality of the audio is low, and the electronic device determines that the audio does not pass verification.

Optionally, when the verification of the audio by the electronic device fails, the electronic device may re-acquire a new audio based on the first text of the audio. For example, if the verification of the audio by the electronic device fails, it indicates that the matching degree between the first text and the first melody is low; therefore, the electronic device may regenerate a new melody based on the first text, thereby obtaining a new song. In this way, the efficiency of music creation may be improved.

The embodiments of the present disclosure provide a method for audio verification. The method includes: acquiring matching information between a melody and chords of the audio and a first proportion of a target melody; and verifying the audio based on the matching information and/or the first proportion. In this way, after the electronic device obtains the audio, the electronic device may process the audio, and when the audio quality is poor, new audio is generated based on the first text again, thereby improving the quality of a song and the efficiency of creating the song.

Based on any one of the foregoing embodiments, the following describes a process of the foregoing method of creating an audio with reference to FIG. 6.

FIG. 6 is a schematic diagram of a process of a method of creating an audio according to an embodiment of the present disclosure. Referring to FIG. 6, the method of creating an audio includes first lyrics, a first model and a second model. The electronic device (not shown in FIG. 6) processes first lyrics to obtain sentence structure information of the first lyrics and inputs the sentence structure information to a first model; the first model may obtain a bar location, a beat location and a playing duration associated with each character in the first lyrics based on the sentence structure information, thereby obtaining the rhyme associated with the first lyrics.

Please refer to FIG. 6, based on the first lyrics, an electronic device matches a plurality of chords with the first lyrics, and inputs the plurality of chords and the rhyme associated with the first lyrics to a second model; and the second model obtains a tone associated with each bar in the first lyrics based on the plurality of chords and rhyme, thereby obtaining a first melody associated with the first lyrics.

Please refer to FIG. 6, the electronic device may obtain a first song based on the first lyrics and the first melody, where a melody of the first song is the first melody, and lyrics of the first song is the first lyrics. After determining the first song, the electronic device may also verify the quality of the first song, and when the quality of the first song is high, the first song may be output. In this way, after acquiring the first lyrics, the electronic device may automatically create a suitable melody for the first lyrics, thereby obtaining the first song. Therefore, the electronic device may quickly create a song based on a segment of lyrics, thereby improving the efficiency of music creation.

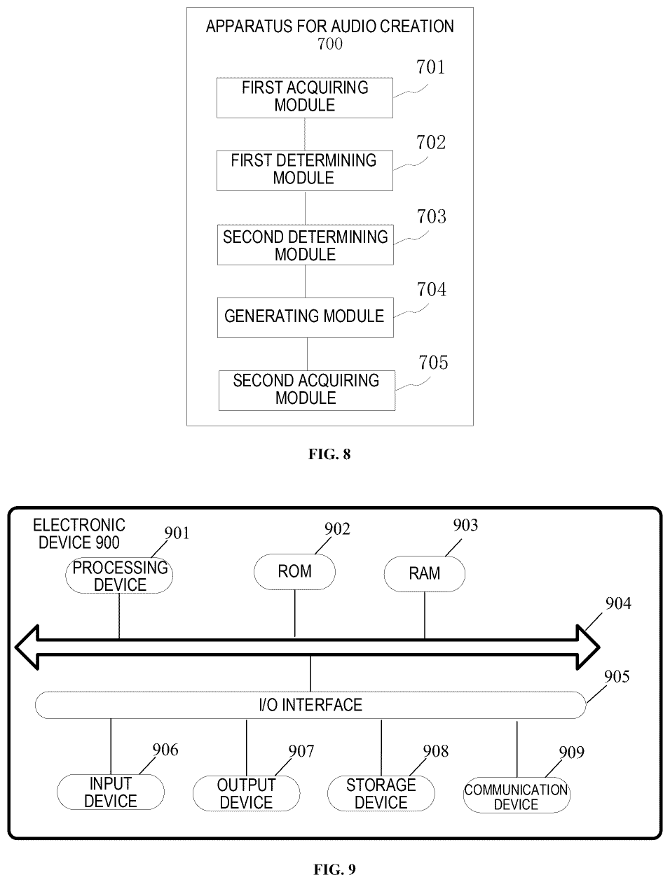

FIG. 7 is a schematic structural diagram of an apparatus for audio creation according to an embodiment of the present disclosure. Referring to FIG. 7, the apparatus for audio creation 700 includes a first acquisition module 701, a first determining module 702, a second determining module 703 and a generating module 704, where:

The first obtaining module 701 is configured to acquire a first text comprising a plurality of characters;

The first determining module 702 is configured to determine rhyme associated with the first text based on the first text, the rhyme indicating rhythm of the plurality of characters;
the second determining module 703 is configured to determine a first melody of the first text based on the first text and the rhyme;
the generating module 704 is configured to generate an audio associated with the first text based on the first melody and the first text.

In a possible implementation, the first determining module 702 is specifically configured to:
determine sentence structure information of the first text based on the first text; and
determine the rhyme associated with the first text based on the sentence structure information.

In a possible implementation, the first determining module 702 is specifically configured to:
determine, based on the sentence structure information, a bar location, a beat location, and a playing duration associated with each character in the first text; and
determine a rhyme of the first text based on the bar location, the beat location, and the playing duration associated with each character.

In a possible implementation, the first determining module 702 is specifically configured to:
for an mth character in the first text;
in response to m being 1, determine a bar location, a beat location, and a playing duration associated with a first character based on structure information of the first character in the sentence structure information; and
in response to m being greater than 1, determine a bar location, a beat location, and a playing duration associated with the mth character based on a bar location, a beat location, and a playing duration associated with a (m−1)th character and the structure information of the mth character in the sentence structure information;
wherein the m is 1, 2, . . . , L, L is the number of characters in the first text.

In a possible implementation, the second determining module 703 is specifically configured to:
determine, based on the first text, a chord associated with each character in the first text; and
determine the first melody of the first text based on a plurality of chords and the rhyme.

In a possible implementation, the second determining module 703 is specifically configured to:
determine a tone associated with each bar in the rhyme based on the plurality of chords; and
determine the first melody based on the tone associated with each bar.

In a possible implementation, the second determining module 703 is specifically configured to:
for an ith bar in the rhyme;
in response to i being 1, determine a tone associated with a first bar based on a rhyme associated with the first bar and a chord associated with the first bar;
in response to the i being greater than 1, determine the tone associated with the ith bar based on a tone associated with a i−1th bar, a rhyme associated with the ith bar, and a chord associated with the ith bar;
wherein the i is 1, 2, . . . , N, N is the number of bars indicated by the rhyme.

The apparatus for audio creation provided in the embodiment of the present disclosure may be used for performing the technical solution of the above method embodiment, and the implementation principle and technical effect thereof are similar and will not be described again in this embodiment.

FIG. 8 is a schematic structural diagram of a further apparatus for audio creation according to an embodiment of the present disclosure. Based on the embodiment shown in FIG. 7, referring to FIG. 8, the apparatus for audio creation 700 further includes a second obtaining module 705 configured to:
acquire matching information between a melody of the audio and a chord, and a first proportion of a target melody, the target melody having an associated text in the audio; and
verify the audio based on the matching information and/or the first proportion.

The apparatus for audio creation provided in the embodiment of the present disclosure may be used for executing the technical solution of the above method embodiment, and the implementation principle and technical effect thereof are similar and will not be described again in this embodiment.

FIG. 9 is a schematic structural diagram of an electronic device according to an embodiment of the present disclosure. Please refer to FIG. 9, it illustrates a structural schematic diagram of an electronic device 900 suitable for implementing the embodiments of the present disclosure. The electronic device 900 may be an electronic device or a terminal device. The electronic device may include, but is not limited to, a mobile terminal such as a mobile phone, a laptop computer, a digital broadcast receiver, a personal digital assistant (Personal Digital Assistant, PDA for short), a tablet computer (Portable Android Device, PAD for short), a portable multimedia player (Portable Media Player, PMP for short), a vehicle-mounted terminal (for example, a vehicle-mounted navigation terminal), and the like, and a fixed terminal such as a digital TV, a desktop computer, and the like. The electronic device shown in FIG. 9 is merely an example and should not bring any limitation to the functions and scope of use of the embodiments of the present disclosure.

As shown in FIG. 9, the electronic device 900 may include a processing device (e.g., central processing unit, graphics processor, etc.) 901 that may perform various suitable actions and processes in accordance with a program stored in a read only memory (ROM) 902 or a program loaded into a random-access memory (RAM) 903 from a storage device 908. In the RAM 903, various programs, and data necessary for the operation of the electronic apparatus 900 are also stored. The processing devices 901, the ROM 902, and the RAM 903 are connected to each other via a bus 904. An input/output (I/O) interface 905 is also connected to the bus 904.

In general, the following devices may be connected to the I/O interface 905: an input device 906 including, for example, a touch screen, touch pad, keyboard, mouse, camera, microphone, accelerometer, gyroscope, or the like; an output device 907 including, for example, a liquid crystal display (LCD), a speaker, a vibrator, or the like; a storage device 908 including, for example, a magnetic tape, a hard disk, or the like; and a communication device 909. The communication device 909 may allow the electronic device 900 to communicate wirelessly or with a further device to exchange data. While FIG. 9 illustrates the electronic device 900 with a variety of devices, it should be understood that it is not required that all of the illustrated devices be implemented or provided. More or fewer devices may alternatively be implemented or provided.

In particular, the processes described above with reference to the flowcharts may be implemented as computer software programs, in accordance with embodiments of the present disclosure. For example, embodiments of the present disclosure include a computer program product including a computer program carried on a computer readable medium. The computer program includes a program code for executing the method as shown in the flowchart. In such an embodiment, the computer program may be downloaded and installed from the network via communications device 1309, installed from storage 1308, or installed from ROM 1302. When the computer program is executed by the processing device 1301, the above-described functions defined in the method according to the embodiment of the present disclosure are executed.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that may contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium (other than the computer readable storage medium) that may communicate, propagate, or transport a program for use by or in connection with an instruction execution system, apparatus, or device. Program code embodied on a computer readable medium may be transmitted using any appropriate medium, including, but not limited to, wireline, optical fiber cable, RF (radio frequency), etc., or any suitable combination of the foregoing.

Optionally, an embodiment of the present disclosure further provides a computer-readable storage medium, the computer-readable storage medium storing computer-executable instructions, and when the computer-executable instructions are executed by a processor, the method as described in any of the above embodiments are implemented.

A further embodiment of the present disclosure further provides a computer program product including a computer program, the computer program, when executed by the processor, implement the method as described in any of the above embodiments.

The computer readable medium may be included in the electronic device, or may exist separately and not be installed in the electronic device.

The computer readable medium carries one or more programs thereon, and when the one or more programs are executed by the electronic device, the electronic device is enabled to execute the method shown in the foregoing embodiments.

Computer program codes for performing the operations of the present disclosure may be written in one or more programming languages or a combination thereof, including but not limited to Object Oriented programming languages-such as Java, Smalltalk, C++, and also conventional procedural programming languages-such as ‘C’ or similar programming languages. The program code may be executed entirely on the user's computer, partially executed on the user's computer, executed as a standalone software package, partially executed on the user's computer and partially on a remote computer, or entirely on a remote computer or electronic device. In the case of involving a remote computer, the remote computer may be any kind of network-including local area network (LAN) or wide area network (WAN)-connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case, for example, a first acquiring unit may also be described as ‘a unit for acquiring at least two internet protocol addresses’.

The functions described herein above may be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium may be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

It should be noted that the modifications of ‘one’ and ‘a plurality of’ mentioned in the present disclosure are illustrative rather than restrictive, and those skilled in the art should understand that they should be understood as ‘one or more’ unless being clearly indicated otherwise.

The names of messages or information interacted between a plurality of devices in the embodiments of the present disclosure are only for illustrative purposes, and are not intended to limit the scope of these messages or information.

It should be understood that, before the technical solutions disclosed in the embodiments of the present disclosure are used, the user should be informed of the type of the personal information, the usage range, the usage scenario, and the like related to the present disclosure in an appropriate manner and the authorization of the user should be obtained according to relevant legal regulations.

For example, in response to receiving an active request from a user, prompt information is sent to the user to explicitly prompt the user that an operation requested by the user will require acquisition and use of personal information of the user. Thus, the user may autonomously select, according to the prompt information, whether to provide personal information for software or hardware such as a terminal device, an application program, an electronic device, or a storage medium that executes the operations of the technical solutions of the present disclosure.

As an optional but non-limiting implementation, in response to receiving an active request from a user, a manner of sending prompt information to the user may be, for example, a manner of a pop-up window, where the pop-up window may present the prompt information in a text manner. In addition, the pop-up window may also carry a selection control for the user to select whether he/she ‘agree’or ‘disagree’to provide personal information to the terminal device.

It may be understood that the above notification and acquisition of the user authorization process are merely exemplary, and do not limit the implementation of the present disclosure, and a further method meeting relevant legal regulations may also be applied to the implementation of the present disclosure.

It is to be understood that the data involved in the technical solution (including but not limited to the data itself, the acquisition or use of the data) should comply with the requirements of the corresponding laws and regulations and related provisions. The data may include information, parameters, and messages, for example, cut flow indication information.

The above description is only embodiments of this disclosure and an explanation of the technical principles used. Those skilled in the art should understand that the scope of the disclosure involved in this disclosure is not limited to technical solutions composed of specific combinations of the above technical features but should also covers a further technical solution formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments may also be implemented in combination in a single embodiment. Conversely, a plurality of features described in the context of a single embodiment may also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

1. A method of creating an audio, comprising:
acquiring a first text comprising a plurality of characters;
determining rhyme associated with the first text based on the first text, the rhyme indicating rhythm of the plurality of characters;
determining a first melody of the first text based on the first text and the rhyme; and
generating an audio associated with the first text based on the first melody and the first text.

2. The method of claim 1, wherein determining the rhyme associated with the first text based on the first text comprises:
determining sentence structure information of the first text based on the first text; and
determining the rhyme associated with the first text based on the sentence structure information.

3. The method of claim 2, wherein determining the rhyme associated with the first text based on the sentence structure information comprises:
determining, based on the sentence structure information, a bar location, a beat location, and a playing duration associated with each character in the first text; and
determining a rhyme of the first text based on the bar location, the beat location, and the playing duration associated with each character.

4. The method of claim 3, wherein determining, based on the sentence structure information, the bar location, the beat location, and the playing duration associated with each character in the first text comprises:
for an mth character in the first text;
in response to m being 1, determining a bar location, a beat location, and a playing duration associated with a first character based on structure information of the first character in the sentence structure information; and
in response to m being greater than 1, determining a bar location, a beat location, and a playing duration associated with the mth character based on a bar location, a beat location, and a playing duration associated with a (m−1)th character and the structure information of the mth character in the sentence structure information;
wherein the m is 1, 2, . . . , L, L is the number of characters in the first text.

5. The method of claim 1, wherein determining the first melody of the first text based on the first text and the rhyme comprises:
determining, based on the first text, a chord associated with each character in the first text; and
determining the first melody of the first text based on a plurality of chords and the rhyme.

6. The method of claim 5, wherein determining the first melody of the first text based on the plurality of chords and the rhyme comprises:
determining a tone associated with each bar in the rhyme based on the plurality of chords; and
determining the first melody based on the tone associated with each bar.

7. The method of claim 6, wherein determining the tone associated with each bar in the rhyme based on the plurality of chords comprises:
for an ith bar in the rhyme;
in response to i being 1, determining a tone associated with a first bar based on a rhyme associated with the first bar and a chord associated with the first bar;
in response to the i being greater than 1, determining the tone associated with the ith bar based on a tone associated with a i−1th bar, a rhyme associated with the ith bar, and a chord associated with the ith bar;
wherein the i is 1, 2, . . . , N, N is the number of bars indicated by the rhyme.

8. The method of claim 1, wherein after generating the audio associated with the first text, the method further comprises:
acquiring matching information between a melody of the audio and a chord, and a first proportion of a target melody, the target melody having an associated text in the audio; and
verifying the audio based on the matching information and/or the first proportion.

9. (canceled)

10. An electronic device, comprising: a processor and a memory;
the memory stores computer executable instructions; and
the processor performing the computer executable instructions stored in the memory, causing the processor to perform acts comprising:
acquiring a first text comprising a plurality of characters;
determining rhyme associated with the first text based on the first text, the rhyme indicating rhythm of the plurality of characters;
determining a first melody of the first text based on the first text and the rhyme; and
generating an audio associated with the first text based on the first melody and the first text.

11. (canceled)

12. The electronic device of claim 10, wherein determining the rhyme associated with the first text based on the first text comprises:
determining sentence structure information of the first text based on the first text; and
determining the rhyme associated with the first text based on the sentence structure information.

13. The electronic device of claim 10, wherein determining the rhyme associated with the first text based on the sentence structure information comprises:
determining, based on the sentence structure information, a bar location, a beat location, and a playing duration associated with each character in the first text; and
determining a rhyme of the first text based on the bar location, the beat location, and the playing duration associated with each character.

14. The electronic device of claim 13, wherein determining, based on the sentence structure information, the bar location, the beat location, and the playing duration associated with each character in the first text comprises:
for an mth character in the first text;
in response to m being 1, determining a bar location, a beat location, and a playing duration associated with a first character based on structure information of the first character in the sentence structure information; and
in response to m being greater than 1, determining a bar location, a beat location, and a playing duration associated with the mth character based on a bar location, a beat location, and a playing duration associated with a (m−1)th character and the structure information of the mth character in the sentence structure information;
wherein the m is 1, 2, . . . , L, L is the number of characters in the first text.

15. The electronic device of claim 10, wherein determining the first melody of the first text based on the first text and the rhyme comprises:
determining, based on the first text, a chord associated with each character in the first text; and
determining the first melody of the first text based on a plurality of chords and the rhyme.

16. The electronic device of claim 15, wherein determining the first melody of the first text based on the plurality of chords and the rhyme comprises:
determining a tone associated with each bar in the rhyme based on the plurality of chords; and
determining the first melody based on the tone associated with each bar.

17. The electronic device of claim 16, wherein determining the tone associated with each bar in the rhyme based on the plurality of chords comprises:
for an ith bar in the rhyme;
in response to i being 1, determining a tone associated with a first bar based on a rhyme associated with the first bar and a chord associated with the first bar;
in response to the i being greater than 1, determining the tone associated with the ith bar based on a tone associated with a i−1th bar, a rhyme associated with the ith bar, and a chord associated with the ith bar;
wherein the i is 1, 2, . . . , N, N is the number of bars indicated by the rhyme.

18. The electronic device of claim 10, wherein after generating the audio associated with the first text, the acts further comprise:
acquiring matching information between a melody of the audio and a chord, and a first proportion of a target melody, the target melody having an associated text in the audio; and
verifying the audio based on the matching information and/or the first proportion.

19. A non-transitory computer readable storage medium, wherein the computer readable storage medium has computer executable instructions stored therein, the computer executable instructions, when performed by a processor, performing acts comprising:
acquiring a first text comprising a plurality of characters;
determining rhyme associated with the first text based on the first text, the rhyme indicating rhythm of the plurality of characters;
determining a first melody of the first text based on the first text and the rhyme; and
generating an audio associated with the first text based on the first melody and the first text.

20. The computer readable storage medium of claim 19, wherein determining the rhyme associated with the first text based on the first text comprises:
determining sentence structure information of the first text based on the first text; and
determining the rhyme associated with the first text based on the sentence structure information.

21. The computer readable storage medium of claim 20, wherein determining the rhyme associated with the first text based on the sentence structure information comprises:
determining, based on the sentence structure information, a bar location, a beat location, and a playing duration associated with each character in the first text; and
determining a rhyme of the first text based on the bar location, the beat location, and the playing duration associated with each character.

22. The computer readable storage medium of claim 21, wherein determining, based on the sentence structure information, the bar location, the beat location, and the playing duration associated with each character in the first text comprises:
for an mth character in the first text;
in response to m being 1, determining a bar location, a beat location, and a playing duration associated with a first character based on structure information of the first character in the sentence structure information; and
in response to m being greater than 1, determining a bar location, a beat location, and a playing duration associated with the mth character based on a bar location, a beat location, and a playing duration associated with a (m−1)th character and the structure information of the mth character in the sentence structure information;
wherein the m is 1, 2, . . . , L, L is the number of characters in the first text.
